(19) United States
(12) Patent Application Publication
(10) Pub. No.: US 2016/0290031 A1
(43) Pub. Date: Oct. 6, 2016

(54) INVISIBLE WINDOW FRAME

(71) Applicant: UNIVERSITÀ POLITECNICA DELLE MARCHE, Ancona (IT)

(72) Inventors: Francesca STAZI, Ancona (IT); Placido MUNAFÒ, Ancona (IT)

(21) Appl. No.: 15/037,350

(22) PCT Filed: Nov. 17, 2014
(86) PCT No.: PCT/IB2014/066098

§ 371 Date: May 18, 2016

(30) Foreign Application Priority Data
Nov. 18, 2013 (IT) MO2013A000317

(51) Int. Cl. E06B 3/663; E06B 7/18; E06B 3/54; E06B 3/64; E05C 7/04; E06B 3/36

(52) U.S. Cl. CPC E06B 3/663; E05C 7/04; E06B 3/362; E06B 3/5409; E06B 3/64; E06B 7/18

(57) ABSTRACT

The window frame (1, 2) comprises: a double glazing (3, 4, 5) which includes two transparent sheets (3, 4); a mobile casing (7, 8) coupled to the double glazing (3, 4, 5); and a fixed casing (13, 14) associable with a wall (16) in which a window is obtained; wherein the mobile casing (7, 8) is substantially housed in the double glazing (3, 4, 5) and is completely covered with at least one of the sheets (3, 4).

### TECHNICAL FIELD

The present invention relates to a window frame.

### BACKGROUND ART

Window frames are known comprising a double glazing borne by a mobile casing, which is hinged to a fixed casing fitted in the window, and which follows the outline of this.

Inside the wall in which the window is obtained, the mock casing is accommodated to which the above fixed casing is fixed.

The fixed and mobile casings can be made of steel, aluminium or other similar materials.

The known frames have quadrangular mobile casings that frame the double glazing, and which abut against the jambs of the fixed casing.

The fixed and mobile casings of known frames have fairly large overall dimensions and this can also have negative drawbacks at aesthetic level which, as is known, is a decisive factor for the commercial success of a frame.

It must be realized that in the technical sector of frame manufacturing, the need is particularly felt to renew the products offered to the public, in order to distinguish them better from those of the competition.

Furthermore, the known frames have unsatisfactory heat insulation, the fixed and mobile casings often being the part of the frames with the lowest heat efficiency.

### DESCRIPTION OF THE INVENTION

The main aim of the present invention is to provide a window frame that differs substantially from those currently offered by the market, in terms of its appearance.

Within this aim, an object of the invention is to provide a window frame that offers high heat efficiency.

Another object of the present invention is to provide a window frame which allows to overcome the mentioned drawbacks of the prior art within the ambit of a simple, rational, easy and effective to use as well as affordable solution.

The above mentioned objects are achieved by the present window frame, made in accordance with claim 1.

### BRIEF DESCRIPTION OF THE DRAWINGS

Other characteristics and advantages of the present invention will become better evident from the description of several preferred but not exclusive embodiments of a window frame, illustrated by way of an indicative, but not limitative, example in the accompanying drawings in which:

FIG. 1 and FIG. 2 are schematic views, in horizontal or vertical cross section, of the ledging area between a mobile sash and a fixed casing of two different embodiments of the frame according to the invention;

FIG. 3 and FIG. 4 are schematic views, in horizontal cross section, of the ledging area between two mobile sashes, relating to said two embodiments of the frame according to the invention;

FIG. 5 is a schematic view of a vertical section of the frame taken at a hinge which connects the mobile sash to the fixed casing;

FIG. 6 and FIG. 7 are axonometric views of the second embodiment of the frame according to the invention according to two opposite points of view;

FIG. 8 is an axonometric view of the frame of FIGS. 6 and 7, sectioned along a horizontal plane;

FIGS. 9 and 10 are enlarged views of the component J and of the component K of FIG. 8, respectively;

FIG. 11 is a vertical sectional view of the frame of the second embodiment of the invention, taken at the ledging area between the mobile sash and the fixed casing;

FIG. 12 is a schematic sectional view of the fixed casing of a variation of the second embodiment of the invention;

FIG. 13 is a schematic view of a detail of a vertical section of sliding sashes of the frame of the invention.

### EMBODIMENTS OF THE INVENTION

With particular reference to these figures, globally indicated by reference numeral 1 and 2 are two embodiments of the window frame of the invention.

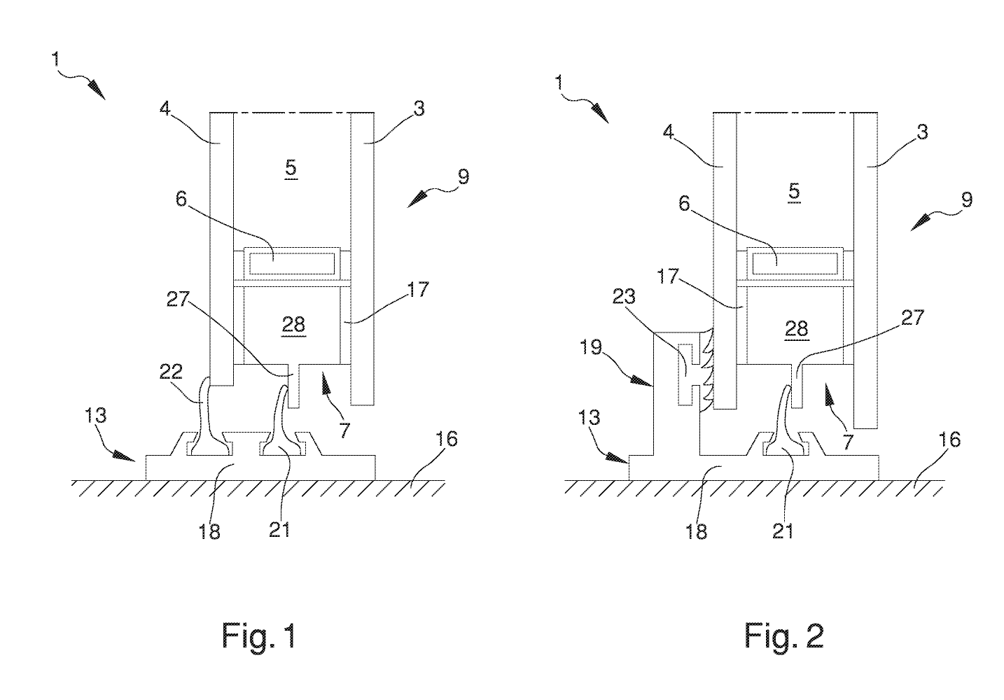

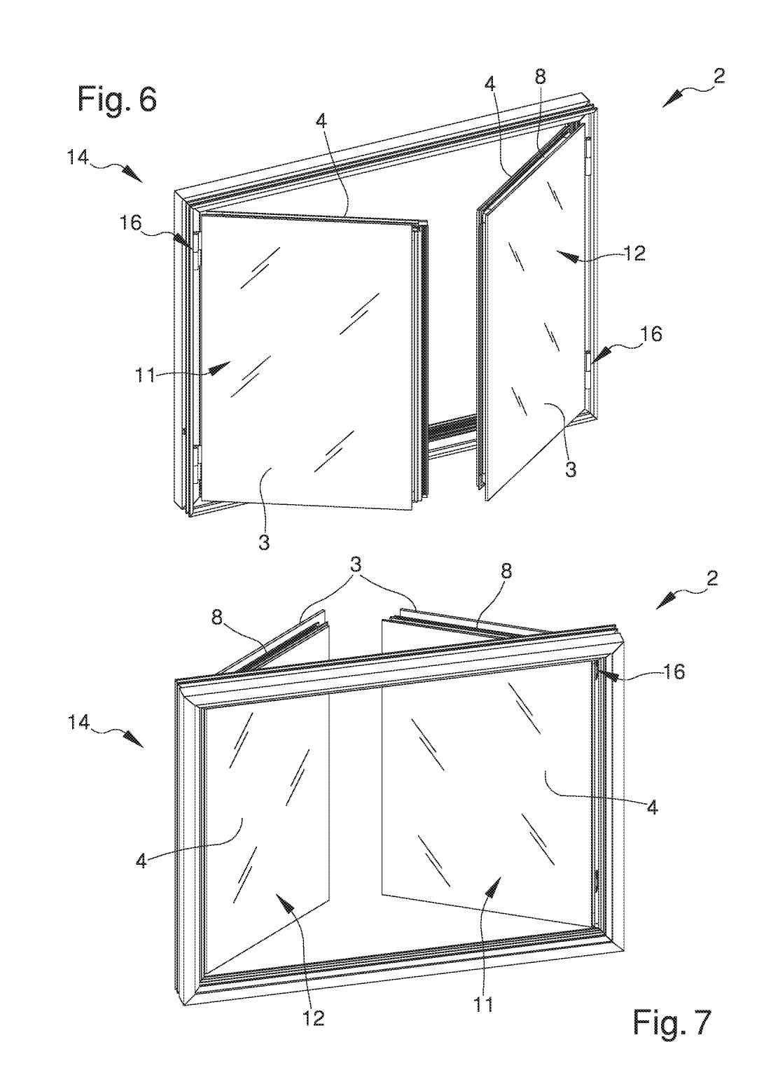

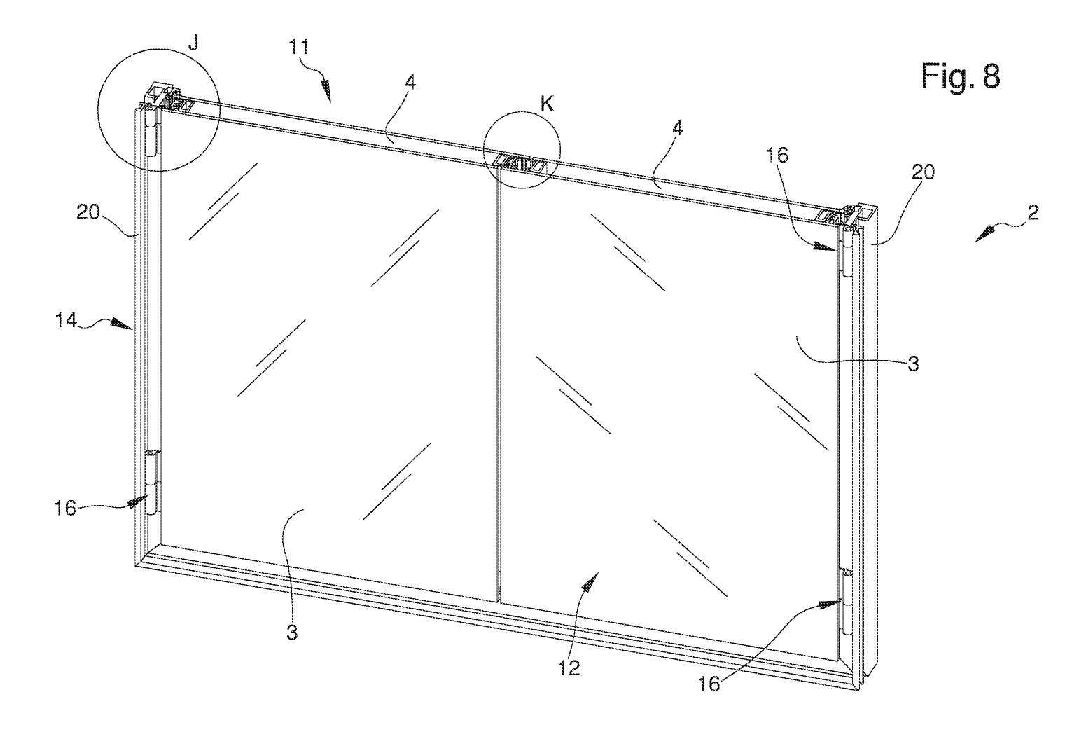

In detail, the first embodiment is shown in FIGS. 1-5, while the second embodiment is shown in FIGS. 6-10.

Some common aspects of the two embodiments of frame 1, 2 are explained below.

The proposed frame 1, 2 comprises at least a double glazing 3, 4, 5, generally of polygon shape, which includes two sheets 3, 4 of transparent material, preferably glass, parallel to one another and separated by an interspace 5.

The glass sheets 3, 4 can e.g. be quadrangular, but other shapes cannot be ruled out.

In the interspace 5 a so-called “molecular sieve” 6 can be included to absorb humidity; alternatively, special belt spacers are used which also act as a sieve (or similar devices) to absorb humidity and reduce heat dispersion.

The double glazing 3, 4, 5 is coupled to a mobile casing 7, 8, to define a mobile sash 9, 10, 11, 12.

The sash 9, 10, 11, 12 is movably associated with a fixed casing 13, 14 which is intended to be embedded, at least in part, in the wall 16 in which the window is obtained.

In particular, the association between fixed casing 13, 14 and mobile casing 7, 8 can be achieved either by means of hinges 15, 16, in case of a swinging sash or a tilt and turn sash, or by means of runners, in the case of a sliding sash.

According to a very important aspect of the invention, the mobile casing 7, 8 is substantially housed in the double glazing 3, 4, 5, i.e., in the above-mentioned interspace 5 and is completely covered with at least one of its sheets 3, 4, hereinafter called first sheet 3.

The sheet facing the first sheet 3 is here called second sheet 4.

Such first sheet 3 is intended in use to be turned towards the inside of the environments delimited by the wall 16, when the frame 1, 2 is closed.

In particular, the mobile casing 7, 8 can be completely contained in the interspace 5 and is covered on opposite sides with both sheets 3, 4.

More in general, the invention envisages that the mobile casing 7, 8 comprises a plurality of profiled elements 28, 41, 42, 43, one or more of which are completely contained in the interspace 5 of the double glazing 3, 4, 5.

In any case, the mobile casing 7, 8 is substantially inside the perimeter of the double glazing 3, 4, 5 and, therefore, substantially hidden, to define a sash 9, 10, 11, 12 which appears identified by the glass sheets 3, 4 only, despite having the structural and thermal characteristics provided by coupling the double glazing 3, 4, 5 and mobile casing 7, 8.

In detail, the profiled elements of the mobile casing 7, 8 are closed in a loop, arranged within the double glazing 3, 4, 5 at respective perimeter portions of same, i.e., at portions that include the outer edges of the glass sheets 3, 4, along the side of their perimeter.

The fixed casing 13, 14 can be made of several profiled elements arranged at the sides of the window, these too closed in a loop, to frame the window itself.

Preferably, the mobile casing 7, 8 and the fixed casing 13, 14 are made completely of pultruded material, e.g., of the type comprising fibreglass and/or carbon fibre or other types of materials.

Nevertheless, cases cannot be ruled out wherein only the mobile casing 7, 8 or only the fixed casing 13, 14 is made of pultruded material, which is a material with high mechanical and thermal efficiency.

To be precise, the casings 7, 8, 13, 14 of the invention include one or more profiled elements made of pultruded material and, preferably, they completely consist of pultruded profiled elements only.

The mobile casing 7, 8 is secured to the sheets 3, 4 of the double glazing 3, 4, 5 by means of an adhesive 17, e.g., with epoxy or polyurethane base, or by means of structural silicone, to define a single product wherein the sheets 3, 4 and the mobile casing cooperate to give the sash its structural and thermal properties.

The fixed casing 13, 14 comprises profiled elements 18, 19, 20 which include an inner portion which, at least in the first embodiment, is fixable to a mock casing 45.

This inner portion is embedded in the above wall 16 together with the mock casing 45.

Furthermore, such profiled elements comprise an outer portion 18, 19, facing the double glazing 3, 4, 5 and having one or more sealing gaskets 21, 22, 23, 24, 44, 67.

Such outer portion 18, 19 can also be at least in part “hidden” being covered with the double glazing 3, 4, 5, when the sash 9, 10 is in closed position and/or when is covered with a layer of plaster or the like.

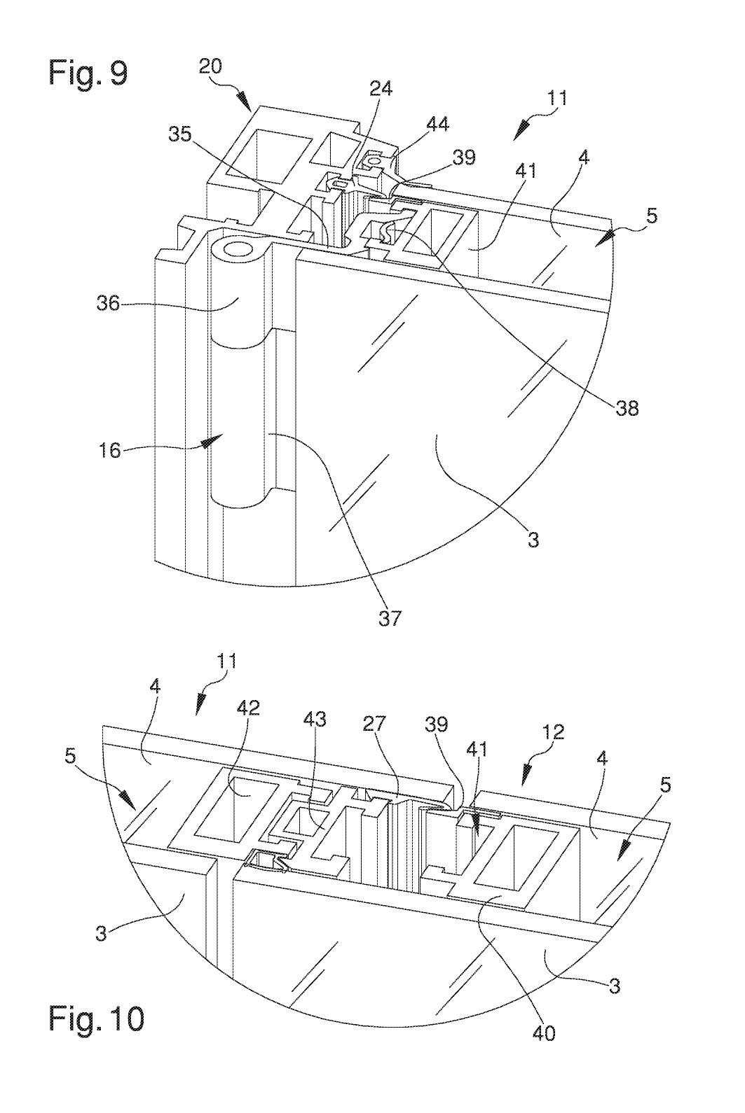

These profiled elements 18, 19, 20 can, in particular, be ledging profiled elements 18, 19 (like those in FIGS. 1 and 2) or hinging profiled elements 20 (like that in FIG. 6 and FIG. 9), as will be more precisely explained later.

In the first embodiment of the invention, the mobile casing 7 forms a longitudinal ribbing 27 able to receive in abutment a sealing gasket, 21, 25, e.g., a sail-shaped gasket fitted on the fixed casing 13, to define a so-called “open” air sealed joint (see FIGS. 1 and 2).

In detail, the mobile casing 7 comprises at least a ledging profiled element 28, which defines the stop of the sash 9, 10, having a main prismatic body, e.g., substantially rectangular, from which the ribbing 27 protrudes.

To be precise, the ribbing 27 is shaped by the side of the profiled element 28 turned towards the outside of the double glazing 3, 4, 5, i.e., towards its perimeter, which ribbing 27 can be arranged centrally to the double glazing 3, 4, 5 and it too can be substantially contained in the interspace 5.

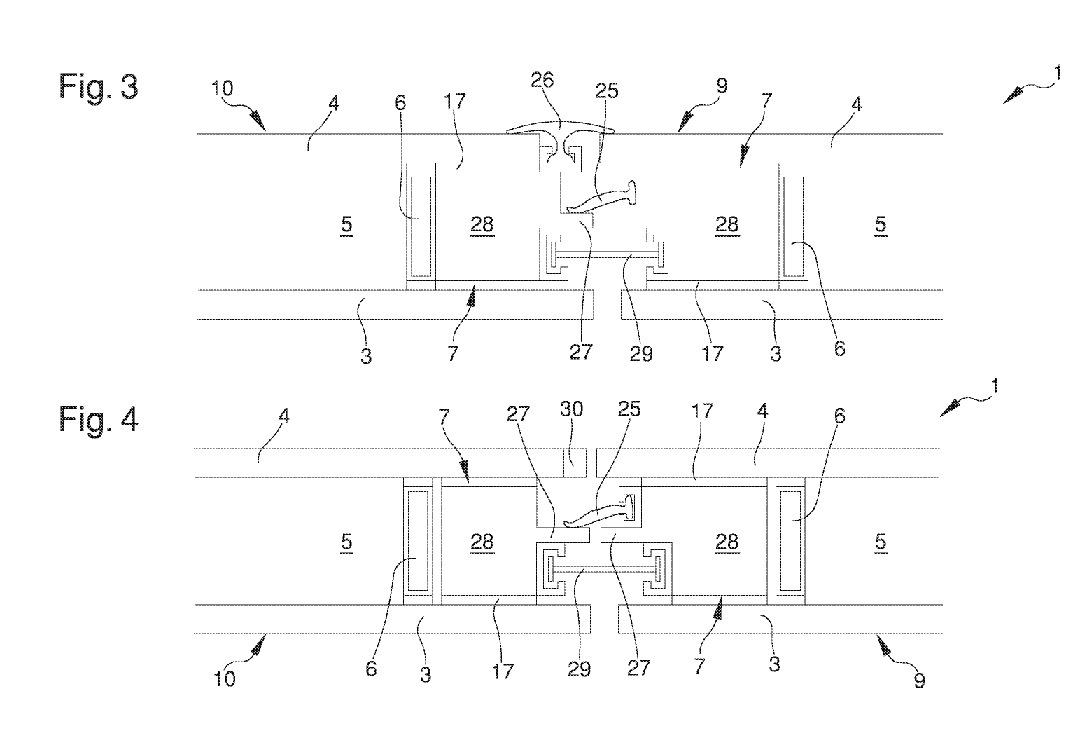

The first embodiment is specially conceived to be implemented on double glazing 3, 4, 5 with an interspace 5 of limited dimensions, i.e., around 24 mm. Furthermore, the first embodiment has two variations both in the case of ledging between a mobile sash 9 and the fixed casing 18, 19, shown in the FIGS. 1 and 2, and in the case of ledging between two mobile sashes 9, 10, shown in the FIGS. 3 and 4.

In the first variation, in the case of closing with ledging between the mobile sash 9 and fixed casing 13, the outer portion 18 of the ledging profiled element of the latter is fitted with two sail-shaped gaskets 21, 22, one of which internal, provided for the abutment with the ribbing 27 of the mobile casing 7 and the other external, ready to abut against the above second sheet 4 of the double glazing 3, 4, 5 (see FIG. 1).

In detail, an outer sail-shaped gasket 22 can also be provided on the other profiled elements of the fixed casing 13 which frame the window, to ensure seal and acoustic insulation along the entire perimeter of the sash.

It should be noticed that the outer portion of the ledging profiled element of the fixed casing 13 defines a thin jamb 18, wherein are formed the seats for said sail-shaped gaskets 21, 22, which jamb 18 can even be only 5 mm thick.

The first sheet 3 can have larger dimensions than the second sheet 4 and protrude with respect to this at the free side of the sash 9 provided for ledging against the fixed casing 13, which is that opposite the hinges 15.

This way, the first sheet 3 covers at least in part the ledging area, to define a uniform and “clean” appearance of the frame.

In the case of closing with two mobile sashes 9, 10 (see FIG. 3), the ledging is made at the free sides of the sashes 9, 10, opposite the hinges 15, in their closing positions wherein the ledging profiled elements 28 of the mobile casings 7 are facing one another.

In practice, each sash 9, 10 includes a ledging profiled element 28 which, in closing position, is parallel and facing that of the other sash.

In this first variation, only one of the two sashes 10 comprises a profiled element 28 having ribbing 27, while the other sash 9 includes a seat for the above-mentioned sail-shaped gasket 25 which abuts against the ribbing 27 itself.

Furthermore, an outer gasket 26 can be provided which abuts against the outer surfaces of the second sheets 4 of the double glazings.

Such outer gasket 26, which is fixed in a seat obtained on one of the mobile casings 7 of the two sashes 9, 10, can e.g. have an anchor-shaped section, like that shown in the illustration.

In order to close and open the two sashes 9, 10, a lock 29 is provided able to fasten in a releasable manner the above-mentioned ledging profiled elements 28 of the mobile casings 7 of the two sashes 9, 10.

This lock 29 is shown in a stylized manner in the FIG. 3 as a double-T connecting the two C-shaped housings of the ledging profiled elements 28 of the two sashes 9, 10.

The lock 29 comprises a lockup mechanism, fitted on the mobile casing 7 of one of the two sashes 9, connected to a handle, which is arranged on the outer surface of the first sheet 3 of such sash 9, and is connected to the mechanism by means of a hole on the sheet 3 itself.

The mechanism includes at least a lock bolt, e.g., in the form of a rod, moving when operated by said handle.

Furthermore, the lock 29 comprises at least a seat for receiving the bolt and is obtained on the ledging profiled element of the other sash 10, to allow locking and releasing the two mobile sashes 9, 10.

A similar lock 29 can be provided in the case of ledging of a single mobile sash 9, with the difference that the seat for the bolt is obtained on the ledging profiled element 18 of the fixed casing 13.

In the second variation, in the case of closing by ledging between the mobile sash 9 and fixed casing 13 (see FIG. 2), the outer portion of the ledging profiled element 18, 19 of the latter has an L shape identified by a thin base jamb 18 from which an outer rib 19 protrudes which bears a brush gasket 23, which abuts against the outer surface of said second sheet 4.

In detail, an outer brush gasket 23 can also be provided on the other profiled elements of the fixed casing 13 which frame the window, to ensure the seal and the acoustic insulation along the entire perimeter of the sash 9.

In this version, the jamb 18 houses a sail-shaped gasket 21, in a substantially central position, provided for the abutment against the ribbing 27 of the mobile casing 7 (see FIG. 2), to define an “open” air seal joint.

In this case as well, the jamb 18 can have a thickness of around 5 mm.

In this version too, the first sheet 3 of the double glazing 3, 4, 5 can have larger dimensions than the second sheet 4 and protrude with respect to the latter at the free side of the double glazing 3, 4, 5 itself, opposite the hinges 15.

In the case of closing with two mobile sashes 9, 10, shown in FIG. 4, the ledging is made by means of the ledging profiled elements 28 of the respective mobile casings 7, placed at the free sides of the sashes 9, 10 which are opposite the hinges 15.

In this second variation, both the sashes 9, 10 comprise a ledging profiled element 28 having ribbing 27, one of which also including a seat for the sail-shaped gasket 25 which abuts against the ribbing 27 of the other ledging profiled element 28.

Furthermore, an outer gasket 30 can be provided, which in this case is a closing gasket 30 glued to the second sheet 4 of one of the sashes 9, 10.

In order to close and open the two sashes, a lock 29 is provided made like that already described for the first version of the first embodiment.

In this case as well, the lock 29 is shown in a stylized manner like a double T which connects two C-shaped housings of the ledging profiled elements 28 of the two sashes 9, 10.

The same lock 29, furthermore, is also used for the case of ledging with a single mobile sash 9 with the changes already explained during the description of the first embodiment.

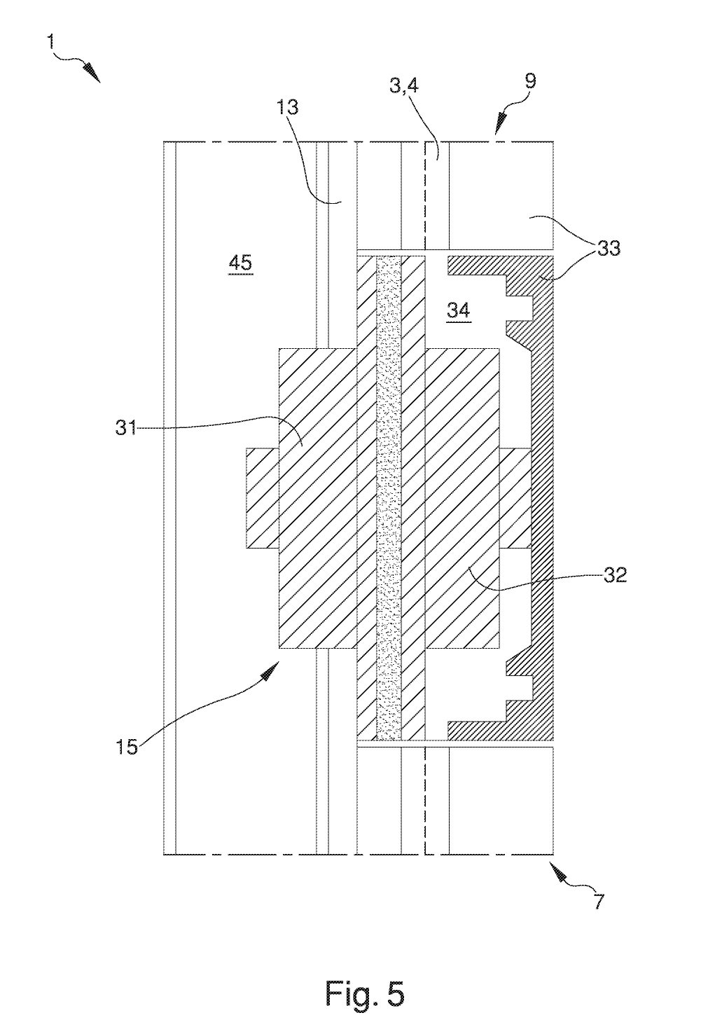

FIG. 5 schematically shows one of the hinges 15 that connect the sash 9 of the first embodiment to its fixed casing 13.

Such hinge includes a fixed part 31 coupled to the fixed casing 13 and a mobile part 32, rotatable with respect to the fixed part 31, coupled integral with a hinging profiled element 33 of the mobile casing 7 of the sash 9.

Preferably, such mobile part 32 is at least partially housed in the above interspace 5, so it is covered with the sheets 3, 4 of the double glazing 3, 4, 5, in particular by the first sheet 3 which protrudes with respect to the second sheet 4, at the edge of the sash 9 facing the fixed casing 13.

For this purpose, the hinging profiled element 33 of the mobile casing 7 comprises a housing 34, i.e., a shaped recess on its profile, which permits accommodating such mobile part 32.

Furthermore, the fixed part 31 of the hinge 15 is preferably at least in part integrated in the mock casing 45 embedded in the wall 16.

The second embodiment is especially conceived to be implemented on double glazings 3, 4, 5 with an interspace 5 32 mm wide, which is a standard measurement corresponding to the thickness of commercial sieves, or of larger dimensions.

It should be noticed that, in this second embodiment, the frame 2 can also have two double glazings.

In the first version of the second embodiment, shown in the FIGS. 6-9, the fixed casing 14 also performs the functions of a mock casing, and is directly fixed to the masonry in which it is embedded, by means of specific screws or the like.

Consequently, advantageously, the frame 2 of the invention comprises the mock casing in the fixed casing 14 and can therefore do without further structures which not only represent a cost and a complication, but above all define a “thermal bridge” which reduces the insulating efficiency of the frame.

In the second embodiment of the frame 2 as well, as shown in the FIG. 9, each hinge 16, which can be of standard type and connects a sash 11, 12 to the fixed casing 14, includes a mobile part 35, 36, which is fixed to a hinging profiled element 37 of the mobile casing 8 of the sash 11, 12 and is at least in part accommodated in the above interspace 5.

The mobile part 35, 36 is rotatably coupled to a fixed part 37 of the hinge 16 which is fixed to the fixed casing 14, and more precisely to one of its hinging profiled elements 20.

Similarly to what occurs with the first embodiment, the sheets 3, 4 of the double glazing 3, 4, 5 of the sash 11, 12 at least partially cover the mobile part 35, 36 of the hinge 16; in particular, such cover is especially implemented by the first sheet 3 which protrudes with respect to the second sheet 4, at the edge of the sash 11, 12 facing the fixed casing 14.

In detail, the hinging profiled element 37 of the mobile casing 8 can shape a C seat that accommodates and integrally engages an arm 35, or strap, of the mobile part of the hinge 16.

Within this seat, a metallic locking element 38 can be interposed between the hinging profiled element 37 and said arm.

The mobile and fixed parts 35, 36, 37 of the hinge 16 comprise respective pintles 36, 37 arranged at the rotation axis of the hinge itself, which are placed alongside the outer portion of the hinging profiled element 20 of the fixed casing 14 and are substantially the only portion of the hinge 35, 36, 37 which remains visible, excepting the possibility of covering them with shielding elements.

The hinging profiled element 20 of the fixed casing 14 can include one or more C seats to accommodate an equal number of sail-shaped gaskets 24, 44, 67.

In detail, a first gasket 24, or inner gasket, can be meant to abut against a ledging element 39, e.g., made of aluminium, positioned between the hinging profiled element 37 of the mobile casing 14 of the sash 11, 12 and the second sheet 4 of the double glazing 3, 4, 5.

Such ledging element 39 can e.g. have a Z-shaped section.

With the ledging element 39 is preferably associated a micrometric setscrew to offset the installation tolerances, so as to ensure the perfect seal of its coupling with the above-mentioned first gasket 24.

The other sail-shaped gasket, or outer gasket 44, is provided to abut against the outer surface of the second sheet 4.

In this case too, an outer sail-shaped gasket 44 can also be provided on the other profiled elements of the fixed casing 14 which frame the window, to ensure seal and acoustic insulation along the entire perimeter of the sash 11, 12.

It should be noticed that, in the hinging profiled element 20, a seat or inner cavity is obtained able to receive an adjustment square for squaring up such profiled element 20 with the horizontal profiled elements coupled by it.

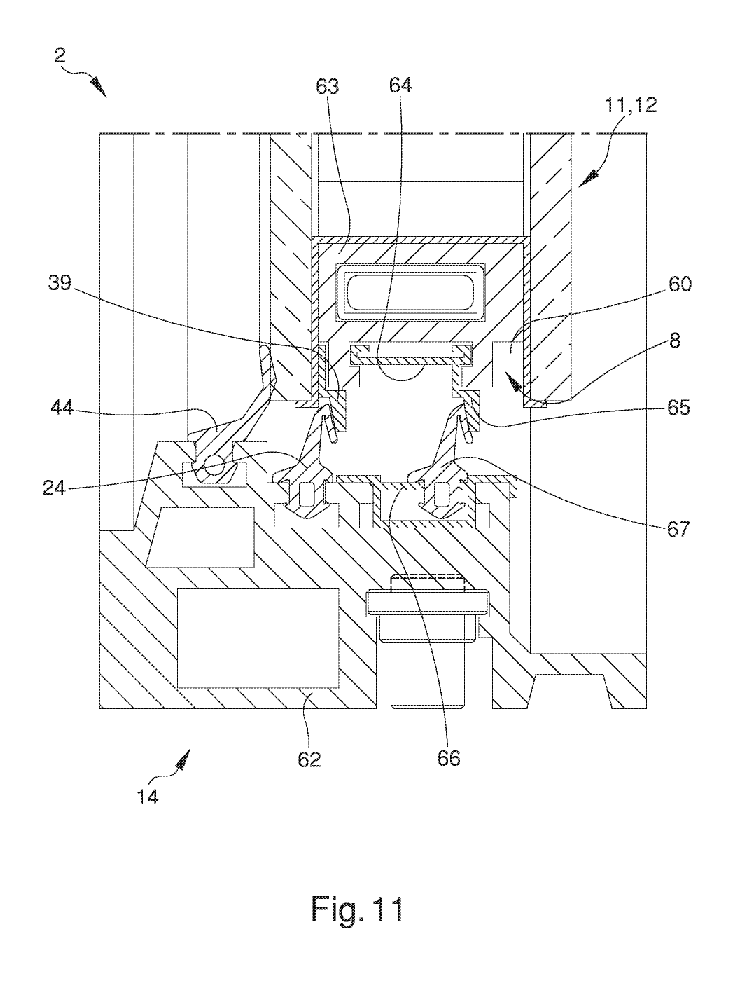

The FIG. 11 shows the ledging area between one of the sashes 11, 12 and the fixed casing 14, at the threshold of the frame 2.

The configuration of this ledging area is similar to that of the hinging area explained above.

In this case, two horizontal profiled elements 62, 63 face one another, a lower one 62 included in the fixed casing 14 which, we recall, also acts as a mock casing, and an upper one 63 included in the mobile casing 8.

The profiled element 62 of the fixed casing 14 accommodates the same gaskets 24, 44, already discussed above in relation to the hinging profiled element 20, just as the profiled element 63 of the mobile casing 8 comprises the Z-shaped ledging element 39.

In addition, the profiled element 63 of the mobile casing houses, in a specific C-shaped seat, an abutting member 64 which forms a further Z-shaped ledging element 65.

Opposite, the profiled element 62 of the fixed casing houses in a respective C-shaped seat a small bracket 66 which bears a further sail-shaped gasket 67 which, in the closing position of the sashes, contacts the above-mentioned further Z-shaped ledging element 65.

In the case of ledging of double mobile sash 11, 12, which is the example shown in the illustrations in relation to the second embodiment of the frame 2, the free ledging extremities of both the sashes 11, 12, i.e., those opposite the hinged extremities, have configurations different the one from the other.

In fact, one of the two sashes 12, the one on the right in the example provided, has the first sheet 3 protruding with respect to the second sheet 4, while for the other sash 11 the contrary applies.

Consequently, in the closing position, the closing area common to the two sashes 11, 12 is covered on the one side with the first sheet 3 of one of the sashes 12, and on the other side by the second sheet 4 of the other sash 11, to define a uniform and clean aspect of the frame 2, which is one of the objects of the invention.

In detail, the ledging profiled element 40 of the mobile casing of one of the sashes 12, arranged at the free extremity of the sash 12, bears the lockup mechanism of the lock, not shown, housed in part in a C-shaped seat 41. Notice that such seat is suitably sized to be able to accommodate a standard lockup mechanism.

Such mechanism can be like that of the first embodiment of the invention.

In this case too, a handle is provided connected to the mechanism by means of a hole made on the first sheet 3 of the mentioned sash 12, which can be at a distance of 6 mm from the edge of the latter. The ledging profiled element 42 of the mobile casing 8 of the other sash 11 is coupled to a connection profiled element 43, fitted in a C-shaped seat provided for the purpose.

Such connection profiled element 43, which can be made of pultruded material, accommodates the seats to receive the bolts of the lockup mechanism in ways already explained.

Preferably, the inner surface of this profiled element 43 is covered with a protective layer, e.g., in PVC, to prevent friction with the bolts from damaging the profiled element itself.

Between the connection profiled element 43 and the second sheet 4 of the respective sash 11 a sail-shaped gasket 27 can be fixed, provided to abut against a ledging element 39, this too equipped with the above setscrew, like that already described above, arranged between the mobile casing 14 of the other sash 12 and the second sheet 4 of its double glazing 3, 4, 5.

In a variation of the second embodiment, the fixed casing 14 of the invention can be coupled with a fixed casing already installed and fixed to a mock casing embedded in the wall.

In detail, such version has been provided to replace a previous frame with the frame 2 of the second embodiment.

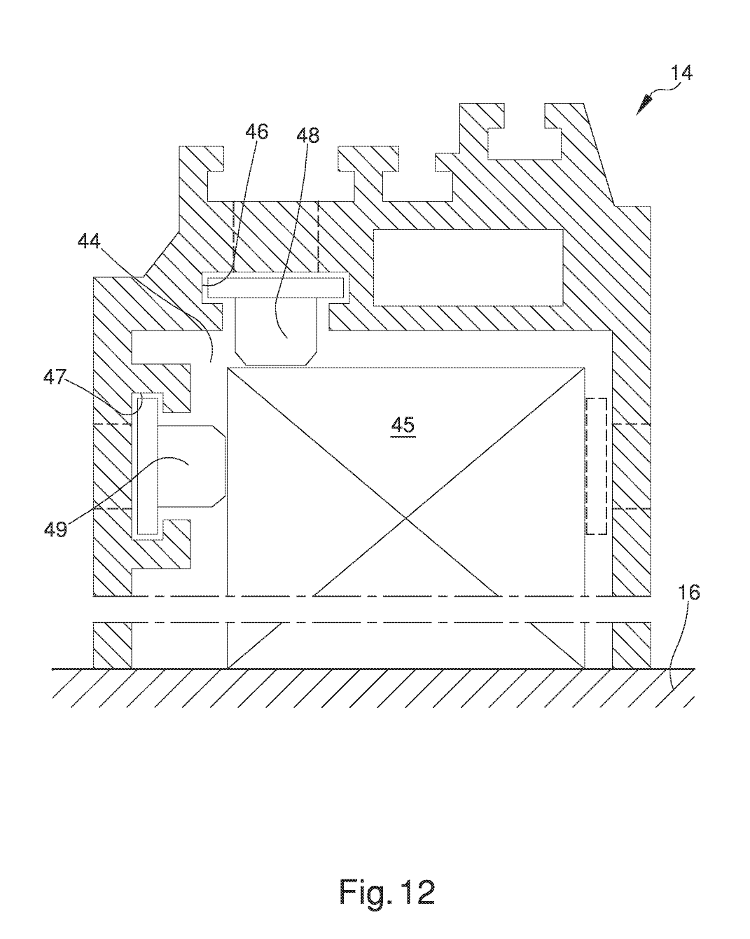

In practice, in the case of wanting to replace an already-installed frame, a user of the invention can opt for the removal of both the previous sashes and the fixed casing and their replacement with the proposed frame 2, or can use the second version of the frame 2, the fixed casing 14 of which is shown in FIG. 12.

In this version, the fixed casing 14 forms a shaped seat 44, opposite the side facing the sash 11, 12, which seat 44 houses the fixed casing 45 of the frame to be replaced.

In this seat 44, housings 46, 47 are obtained that accommodate respective set and fastening screws 48, 49 to join the fixed casing 45 of the previous frame to the fixed casing 14 of the invention and to centre it in the seat 44.

Consequently, to make replacement, it is enough to simply remove the sashes of the previous frame and fit the fixed casing 14 of the invention on the fixed casing 45 already installed, accommodating the latter in the housing 45.

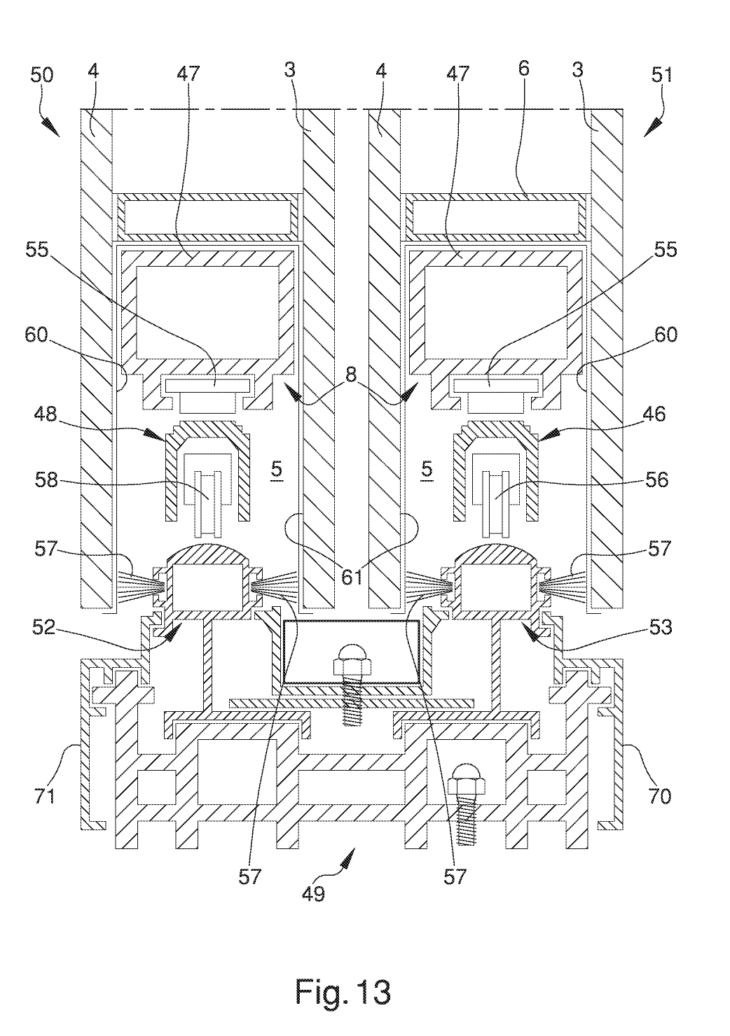

FIG. 13 shows the frame 2 of the invention in its version with sliding sash 50, 51.

For the sake of precision, on the attached drawing tables, the case is shown of a frame 2 with double sliding sash, i.e., having two sashes 50, 51 sliding in an independent way.

Nevertheless, the invention is not restricted by the number of sliding sashes 50, 51 that can be fitted.

In this variation, each sash 50, 51 includes, completely contained in the interspace 5 of its own double glazing, at least a sliding trolley 46, 48 secured to the mobile casing.

For the sake of precision, the trolleys 46, 48 are positioned at the opposite upper and lower extremities of the respective sash 50, 51, i.e., they are borne by upper and lower horizontal profiled elements 47 of the mobile casing 8.

The top or bottom profiled elements 47 of this variation are like that previously described for the frame 2 with revolving sashes, with the difference that they are spaced from the edge of the two sheets 3, 4 of the relative double glazing enough to accommodate in the interspace 5 the above-mentioned trolley 46 and a relative guide track 52, 53 fixed to the fixed casing 14, on which the trolley 46, 48 runs.

In practice, a single horizontal profiled element 49 of the fixed casing 14 (which also integrates the mock casing, in the way already explained above) can bear two fixed parallel tracks 52, 53, defined by an equal number of profiled elements, made e.g. of aluminium, which protrude within the interspaces 5 of the respective sashes 50, 51.

Each horizontal profiled element 47 of the mobile casing 8 of each sliding sash 50, 51 includes a C-shaped seat wherein is housed a plug 55, e.g., of polyamide, steel or pultruded material, to which is screwed a fixed body 53, 54 of the relative trolley 46, 48, which body 53, 54 bears its own roller 55, 56, e.g., of aluminium, which slides on the above-mentioned track 52, 53.

Each track 52, 53 has, at its sides, brush gaskets 57 that contact the inner sides of the sheets 3, 4 of the sliding sashes 50, 51.

Optionally, each sash 50, 51 can include, internally, metal glass supporting strips 60, 61, e.g., of steel, which connect the mobile casing 8 to the free edges of the sheets 3, 4 of the double glazing.

Furthermore, the sides of the base profiled element 49 of the fixed casing 14 can be covered with shaped guards 70, 71 shown in FIG. 13.

It has in practice been ascertained how the described invention achieves the proposed objects and in particular, the fact is underlined that it makes available a frame 1, 2 which, though having structural and thermal characteristics superior to those of known frames, appears made substantially only of glass or in any case made to a large extent from the glass of the sheets 3, 4 of the double glazing. This way, a frame 1, 2 is presented with a particularly clean and original line, able to strongly distinguish itself from the frames currently on the market.

1) Window frame (1, 2) comprising: at least a double glazing (3, 4, 5) which includes at least two transparent sheets (3, 4); at least a mobile casing (7, 8) coupled to said double glazing (3, 4, 5); and at least a fixed casing (13, 14) associable with a wall (16) in which a window is obtained; wherein said mobile casing (7, 8) is substantially housed in said double glazing (3, 4, 5) and is completely covered with at least one of said sheets (3, 4).

2) Frame (1, 2) according to the claim 1, wherein said mobile casing (7, 8) comprises a plurality of profiled elements (18, 19, 20, 28, 33, 37, 40, 42, 49) at least one of which is completely contained within said double glazing (3, 4, 5).

3) Frame (1, 2) according to claim 1, wherein at least one of said mobile casing (7, 8) and said fixed casing (13, 14) is at least partly made with a pultruded profile.

4) Frame (1, 2) according to claim 3, wherein said mobile casing (7, 8) and fixed casing (13, 14) are completely made with a pultruded profile.

5) Frame (1, 2) according to claim 1, wherein said mobile casing (7, 8) comprises a plurality of profiled elements (28, 33, 37, 40, 42) arranged within said double glazing (3, 4, 5) in correspondence to its respective outer portions.

6) Frame (1, 2) according to claim 1, wherein said mobile casing (7, 8) is secured to at least one of said sheets (3, 4) by means of an epoxy-based adhesive (17) or by means of structural silicone.

7) Frame (1) according to claim 1, wherein said mobile casing (7) forms at least a ribbing (27) able to receive in abutment a sealing gasket (21, 25).

8) Frame (1, 2) according to claim 1, wherein said fixed casing (13, 14) comprises at least a profiled element (18, 19, 20) which includes an inner portion which can be embedded in said wall (16), and an outer portion (18, 19), facing said double glazing (3, 4, 5) and having one or more sealing gaskets (21, 22, 23, 24, 44).

9) Frame (1, 2) according to claim 1, comprising a hinge (15, 16) having at least a fixed part (31, 37) coupled to said fixed casing (13, 14) and at least a mobile part (32, 35, 36) which is coupled to said mobile casing (7, 8) and which is at least partly housed in said double glazing (3, 4, 5).

10) Frame (1, 2) according to claim 1, comprising a lock (29) which includes a lockup mechanism, fitted on the mobile casing (7, 8) and at least partly housed within said double glazing (3, 4, 5), said mechanism comprising at least a lock bolt, moving when operated by a handle.

11) Frame (2) according to claim 1, comprising at least a sliding sash (50, 51) which comprises, contained in the interspace (5) of its double glazing, at least a sliding trolley (46, 48) secured to said mobile casing (8).

12) Frame according to the claim 11, characterized by the fact that it comprises at least a profiled element (49) of said fixed casing (14) on which is fastened at least a track (52, 53) on which slides said trolley (46, 48), said track (52, 53) protruding within said interspace (5) of said sash (50, 51).

13) Frame (2) according to claim 1, wherein said fixed casing (14) forms a shaped seat (44) to house a fixed casing (45) of a frame to replace, previously installed on a wall (16).
